(19) United States
(12) Patent Application Publication
(10) Pub. No.: US 2026/0280297 A1
(43) Pub. Date: Sep. 17, 2026

(54) METHOD FOR MANAGING THE BALANCING OF THE LOADS ON A POLYPHASE ELECTRICAL NETWORK, BALANCING DEVICE AND CORRESPONDING COMPUTER PROGRAM

(71) Applicant: SAGEMCOM ENERGY & TELECOM SAS, Bois-Colombes (FR)

(72) Inventors: Henri TEBOULLE, Bois-Colombes (FR); Christophe GRINCOURT, Bois-Colombes (FR)

(73) Assignee: SAGEMCOM ENERGY & TELECOM SAS, Bois-Colombes (FR)

(21) Appl. No.: 19/566,799

(22) Filed: Mar. 13, 2026

(30) Foreign Application Priority Data
Mar. 14, 2025 (FR) 2502585

(51) Int. Cl. H02J 3/28; G05B 13/02; H02J 3/00

(52) U.S. Cl. CPC H02J 3/28; G05B 13/026; H02J 3/003

(57) ABSTRACT

A method and a device for managing the balancing of the loads in an electrical network comprising a plurality of phases are proposed here. The method is implemented in a management device and includes: obtaining, for connection points, first data representing at least one phase to which the connection points are connected, and second data representing a consumption of electrical energy over a predetermined period for said at least one phase, then determining, according to the first and second data, a predicted total electrical energy consumption over a predetermined period for each phase in said plurality of phases, and detecting a load unbalance between said phases from said predicted total electrical energy consumption, and, when a load unbalance is detected, then executing a phase connection change.

### TECHNICAL FIELD

The present disclosure relates to the management of polyphase electricity distribution networks. More particularly, the present disclosure relates to the management of the balancing of the loads on such polyphase electricity distribution networks.

### PRIOR ART

Electricity distribution networks (also hereinafter referred to as “electrical networks” or “polyphase electrical networks”) are mainly polyphase. More particularly, electricity distribution networks are in general three-phase. In this case, the electricity is distributed via three distinct phase conductors (also hereinafter simply referred to as “phases”). This allows more effective use of energy by distributing the load over several phase conductors.

The term “load” refers to the quantity of electricity demanded by users (also hereinafter referred to as “subscribers”) at a given moment. It is directly related to the phase of the polyphase electricity distribution network since the load may be distributed over all the phases or concentrated on a single phase. A balanced distribution of the load between the phases optimises the operation of the electricity distribution network and prevents overloads on a specific phase. Thus, balancing the loads between the various phases is essential for electricity suppliers.

When a subscriber is installed, the phase of the network to which they are connected is selected definitively. However, consumption may vary from one subscriber to another and fluctuate over time. A subscriber may add high-consumption appliances (e.g. swimming pool, jacuzzi, electric car, etc). They may also install electricity generators (e.g. solar panels, wind turbines, etc). These additions create an unbalance of the loads that cannot easily be compensated for.

A load unbalance may cause voltage fluctuations. This disturbs the stability of the distribution network and may cause faults. An unbalance also causes overheating of equipment, especially three-phase motors. Overheating may degrade the insulation of the cables and equipment. This increases the risk of short-circuits and failures. Furthermore, a load unbalance reduces energy efficiency and may damage equipment. In large-scale systems, a persistent unbalance may cause electrical faults.

The prior art does not propose satisfactory solutions for solving this problem. There is at the present time no effective solution for correctly balancing the distribution of energy between the phases of an electricity distribution network.

The situation can therefore be improved. It is in particular desirable to provide a solution for distributing the load between the various phases of the distribution network in an optimised manner, thus ensuring more balanced use of energy, a reduction in risks of overload and an improvement in the global energy performance of the distribution network.

### DISCLOSURE OF THE INVENTION

A method is proposed here for managing the balancing of the loads in an electrical network comprising a plurality of phases supplying electrical energy to a set of connection points adapted to connect an electrical installation of a subscriber to said electrical network. The method is implemented in a management device and comprises:
obtaining, for each connection point, first data representing at least one phase from said plurality of phases to which each connection point is connected,
obtaining, for each connection point, second data representing a consumption of electrical energy over a predetermined period for said at least one phase to which said connection point is connected,
estimating, according to the first data and a mean consumption determined on the basis of said second data, a predicted total electrical energy consumption over a predetermined period for each phase in said plurality of phases,
detecting any load unbalance between said phases from said predicted total electrical energy consumption,
and, when a load unbalance is detected, then commanding a phase connection change, said phase connection change comprising:
classifying, by decreasing order of predicted total electrical energy consumption over the predetermined period, said phases in said plurality of phases, a first phase being a phase having the highest predicted total electrical energy consumption, a second phase being a phase having an intermediate predicted total electrical energy consumption, a third phase being a phase having the lowest predicted total electrical energy consumption;
for said first phase, selecting a first set of connection points selected from a group of connection points supplied by said first phase, until a predicted total electrical energy consumption over the predetermined period of the connection points reaches a first predetermined gain in consumption.

Advantageously, the method according to the invention makes it possible to detect in real time any load unbalance between the phases of a polyphase electrical network. By means of the analysis of the electrical energy consumption of each connection point supplied by the phases of the electrical network, it is possible to determine for each phase what is the total electrical energy consumption thereof and thus to deduce therefrom whether there is a load unbalance. In the case of detection of a load unbalance, the method according to the invention then makes it possible automatically and in real time to control the phase (or the order of the phases) to which each connection point is connected in order to rebalance the loads of each phase.

According to one embodiment, detecting a load unbalance between said phases comprises: determining, from said predicted total electrical energy consumption of each phase, the phases having a predicted total electrical energy consumption over the predetermined period that is the highest, and respectively the lowest, and, if a difference in predicted total electrical energy consumption between the phases having the highest and the lowest predicted total electrical energy consumption is above a predetermined threshold, then said load unbalance is detected.

According to a particular embodiment, selecting, for said first phase, said first set of connection points is performed in a decreasing order of predicted mean electrical energy consumption over the predetermined period, and commanding said phase connection change furthermore comprises:
if a predicted total electrical energy consumption of said second phase is higher than a predetermined threshold, then:
commanding a switching of the connection points of said first selected set onto a connection to said third phase, and
selecting, in a decreasing order of a predicted mean electrical energy consumption over the predetermined period, a second set of connection points selected from a group of connection points supplied by said second phase, until a predicted total electrical energy consumption over the predetermined period of the connection points reaches a second predetermined gain in consumption, and commanding a switching of the connection points of said second selected set onto a connection to said third phase.

According to a particular embodiment, commanding said phase connection change furthermore comprises:
when the predicted total electrical energy consumption of said second phase is below or equal to a predetermined threshold, then
selecting, in a decreasing order of a predicted mean electrical energy consumption over the predetermined period, a third set of connection points selected from the connection points of said first set, until a predicted total electrical energy consumption over the predetermined period of the connection points reaches a third predetermined gain in consumption, and commanding a switching of the connection points of said third set onto a connection to said third phase, and
selecting, in a decreasing order of a predicted mean electrical energy consumption over the predetermined period, the remaining connection points of said first set and commanding a switching of the remaining connection points of said first set onto a connection to said second phase.

According to a particular embodiment, selecting, for said first phase, said first set of connection points performed randomly, and commanding said phase connection change furthermore comprises:
if a predicted total electrical energy consumption of said second phase is higher than a predetermined threshold, then:
commanding a switching of the connection points of said first selected set onto a connection to said third phase, and
selecting, randomly, a second set of connection points selected from a group of connection points supplied by said second phase, until a predicted total electrical energy consumption over the predetermined period of the connection points reaches a second predetermined gain in consumption, and commanding a switching of the connection points of said second selected set onto a connection to said third phase.

According to a particular embodiment, commanding said phase connection change furthermore comprises:
when the predicted total electrical energy consumption of said second phase is below or equal to a predetermined threshold, then
selecting, randomly, a third set of connection points selected from said first set until a predicted total electrical energy consumption over the predetermined period of the connection points reaches a third predetermined gain in consumption, and commanding a switching of the connection points of said third set onto a connection to said third phase, and
selecting the remaining connection points of said first set and commanding a switching of the remaining connection points of said first set onto a connection to said second phase.

A device is also proposed here for managing the balancing of the loads in an electrical network comprising a plurality of phases supplying electrical energy to a set of connection points adapted to connect an electrical installation of a subscriber to said electrical network. The management device comprises electronic circuitry configured to:
obtain, for each connection point, first data representing at least one phase from said plurality of phases to which each connection point is connected,
obtain, for each connection point, second data representing a consumption of electrical energy over a predetermined period for said at least one phase to which said connection point is connected,
estimate, according to the first data and a mean consumption determined on the basis of said second data, a predicted total electrical energy consumption over a predetermined period for each phase in said plurality of phases,
detect any load unbalance between said phases from said predicted total electrical energy consumption,
and, when a load unbalance is detected, then commanding a phase connection change, said phase connection change comprising:
classifying, by decreasing order of predicted total electrical energy consumption over the predetermined period, said phases in said plurality of phases, a first phase being a phase having the highest predicted total electrical energy consumption, a second phase being a phase having an intermediate predicted total electrical energy consumption, a third phase being a phase having the lowest predicted total electrical energy consumption;
for said first phase, selecting a first set of connection points selected from a group of connection points supplied by said first phase, until a predicted total electrical energy consumption over the predetermined period of the connection points reaches a first predetermined gain in consumption.

According to one embodiment, the management device is integrated in an information system of an electricity supplier.

According to one particular embodiment, the management device is integrated in a data concentrator.

A computer program product is also proposed, comprising instructions causing the execution, by a processor, of the above-mentioned method according to any one of the embodiments thereof, when said instructions are read and executed by the processor.

A storage medium is also proposed, storing such instructions causing the execution, by the processor, of the method mentioned above according to any one of the embodiments thereof, when said instructions are read from the storage medium and executed by the processor.

### BRIEF DESCRIPTION OF THE DRAWINGS

The features of the invention mentioned above, as well as others, will emerge more clearly from the reading of the following description of at least one example embodiment, said description being made in relation to the accompanying drawings, among which:

FIG. 1A and FIG. 1B illustrate schematically examples of an environment for implementing the method for balancing loads in a polyphase electrical network, according to embodiments;

FIG. 2 illustrates schematically an example of a hardware platform for implementing, in the form of electronic circuitry, a device for managing the balancing of the loads in a polyphase electrical network, according to one embodiment;

FIG. 3 illustrates schematically the steps of the method for managing the balancing of loads in a polyphase electrical network, according to one embodiment.

FIG. 4 illustrates schematically certain steps of the method for managing the balancing of loads in a polyphase electrical network, according to one embodiment.

FIG. 5 illustrates schematically certain steps of the method for managing the balancing of loads in a polyphase electrical network, according to another embodiment;

FIG. 6A, FIG. 6B and FIG. 6C illustrate in flow diagram form examples of the communication flows during the method for balancing loads in a polyphase electrical network, according to embodiments;

### DETAILED DISCLOSURE OF EMBODIMENTS

The general principle of the present disclosure consists in modifying, at any moment, according to the load and each of the phases of the electrical network, the phase or phases to which a single-phase or polyphase connection point of an electrical installation of a subscriber is or are initially connected. More particularly, the present disclosure relates to a method for switching from a connection to one or more phases to which the connection point is initially connected to a connection to one or more new phases, according to the load on each of the phases of the electrical network.

In fact, as mentioned previously, the choice of the phase of the electrical network to which the connection point of the subscriber is connected is made definitively, at the time of the connection of the electrical installation of the subscriber to the electrical network. It is therefore not possible to balance the loads on the electrical network by changing the choice of the phase to which the connection point of the electrical installation of the subscriber is connected.

The term “single-phase or polyphase connection point” (also referred to as “connection point”) refers here to a connection point of the electrical installation of the subscriber that is connected to one or more so-called “input” phases of the electricity distribution network. This connection point is either single-phase (i.e. a single “outgoing” phase supplies the electrical installation of the subscriber), or polyphase (i.e. several “outgoing” phases supply the electrical installation of the subscriber). Hereinafter, the term “input phase” refers to a phase of the electrical network arriving at the connection point, and the term “output phase” refers to a phase starting from the connection point and supplying electricity to the installation of the subscriber.

Thus the connection point constitutes an interface between the electrical installation of the subscriber and the electrical network supplying electricity to the domestic or industrial installation of a subscriber. In general, this connection point is equipped with an electricity meter, for measuring the electricity supplied to the subscriber.

The objective is therefore to be able to change the phase or phases of the electrical network to which the output phase or phases of the connection point of the electrical installation of the subscriber are initially connected, according to the load level of each phase of the electrical network, in order to be able to optimise the balancing of the loads of the phases of the electrical network when necessary.

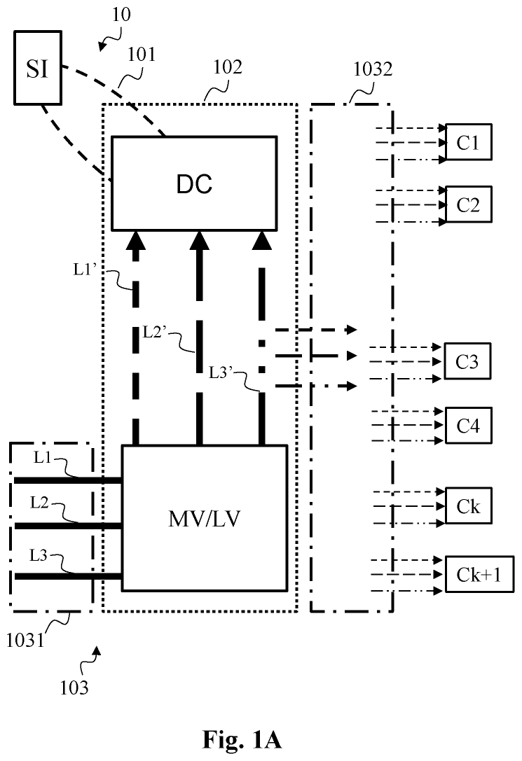

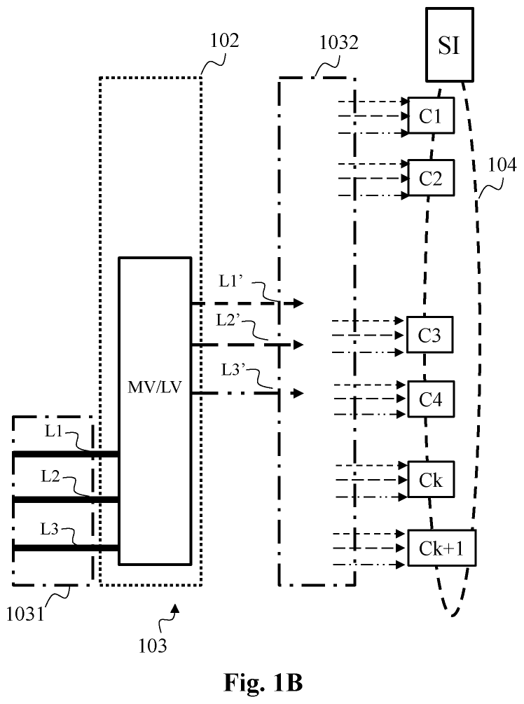

FIG. 1A and FIG. 1B thus illustrate schematically examples of an environment for implementing the method for managing the balancing of loads in a polyphase electrical network, according to embodiments.

In these non-limitative examples, a network for conveying electricity conveys the electricity from the production stations to the end users (or subscribers), such as homes or businesses. Such an electricity-conveying network comprises in particular a transport network (which transports the electricity over long distances at high voltage) and the distribution network 103 (which brings the electricity at lower voltage levels for the consumer in homes or businesses). The electricity distribution network 103 comprises two types of network: a medium-voltage network 1031 comprising medium-voltage lines (voltage between 15 kV and 30 kV) and a low-voltage network 1032 comprising low-voltage lines (voltage of 230 V or 400 V). An MV/LV transformer (or MV/LV transformer station) included in a substation 102 provides the connection between the medium-voltage lines and the low-voltage lines. In particular, the MV/LV transformer reduces the medium voltage to a lower voltage (220 V to 400 V) to make it compatible with domestic and industrial use. Thus the low-voltage lines of the low-voltage network 1032 serve to supply electricity to the electrical installations of the subscribers from the MV/LV transformer to homes and businesses.

As mentioned above, the electricity distribution network 103 is in general polyphase in order to guarantee balanced and effective distribution of electrical energy. More particularly, high-voltage 1031 and low-voltage 1032 electrical networks are in general composed of three conductors of distinct phases L1, L2, L3, respectively L1′, L2′, L3′ (also hereinafter referred to as “phase”) and, where applicable, a neutral phase conductor (also hereinafter referred to as “neutral”). The electrical network 103 is then said to be “three-phase”. It should be noted that other types of polyphase electrical network exist, such as electrical networks comprising only two phase conductors (a so-called “two-phase” electrical network).

It should be noted that hereinafter the electrical network considered is the low-voltage three-phase electrical network 1032 and the input phases are the phases denoted L1′, L2′, L3′ starting from the MV/LV transformer of the substation 102.

The electrical network 1032 conveys the electricity as far as the connection point (single-phase or polyphase) of the subscriber in their home or business, where an electricity meter measures the electrical energy consumption. These electricity meters are sometimes equipped with communication interfaces allowing the remote collection of consumption data (e.g. smart electricity meters). For example, electricity meters may incorporate a communication interface enabling them to communicate via a communication network of the powerline communication network (or PLC) type, facilitating the transmission of data, at regular intervals or according to specific requirements, to an information system of an electricity supplier or a data concentrator, for centralised processing thereof. In fact the information systems or data concentrators collect and centralise the consumption data coming from various electricity meters equipping various connection points. The data concentrators distribute the collection load and act as relays between the electricity meters and the information systems. They play a crucial role in energy management, allowing real-time monitoring of consumptions and rapid detection of any abnormalities or unbalances. The data collected are next transmitted to the electricity supplier and processed for optimum management of the whole of the electrical network, thus facilitating maintenance and optimisation of this network.

According to one embodiment (see for example FIG. 1A), a system 10 for managing electricity meters comprises at least one information system SI and at least one data concentrator DC. The information system SI and the data concentrator DC are configured to communicate together via a first communication network 101. For example, the first communication network 101 is a cellular communication network complying with the 2G to 5G, LTE-M or NB-IoT (“Narrow Band Internet-of-Things”) specifications. The data concentrator or concentrators DC are configured to communicate, furthermore, with a set of electricity meters C1 to Ck+1 via a second communication network (not shown in FIG. 1A). The second communication network is, for example, a PLC network complying with the G3-PLC or PRIME, or G3-Hybrid or PRIME-Hybrid specifications.

Moreover, it should be noted that, in the example in FIG. 1A, the data concentrator DC is connected to the input phases L1′, L2′, L3′ starting from the MV/LV transformer.

According to another embodiment (see for example FIG. 1B), the management system 10 comprises only at least one information system SI. The information system SI and the meters C1 to Ck+1 are configured to communicate together directly via a communication network 104, for example complying with the 2G to 5G, LTE-M or NB-IoT specifications.

In the examples described above, the electricity meters C1 to Ck+1 equip a connection point at a subscriber and are configured to measure consumption, by this subscriber, of an electricity resource that is distributed from the connection point to the equipment via an electrical installation. The electricity meters C1 to Ck+1 are furthermore configured to transmit to the information system SI directly (FIG. 1B) or, where applicable, via the data concentrator DC (FIG. 1A), consumption data representing the consumption of the subscriber over a predetermined period. For example, the electricity meters C1 to Ck+1 transmit daily consumption data every day.

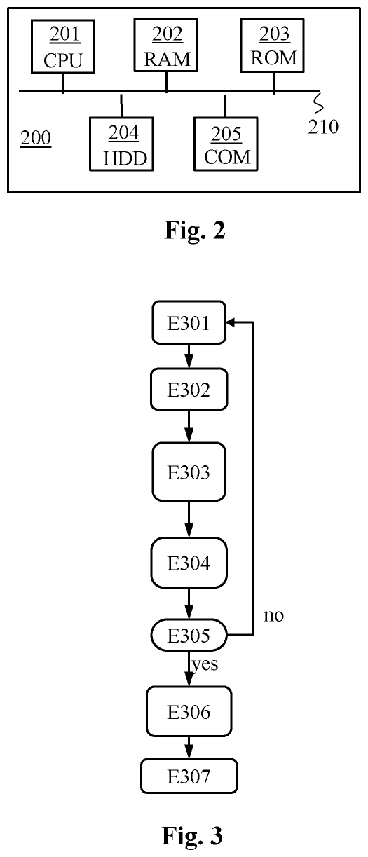

FIG. 2 illustrates schematically an example of a hardware platform for implementing, in the form of electronic circuitry, a device for managing the balancing (or management device 200) of the loads in a polyphase electrical network 1032, according to one embodiment.

The hardware platform comprises, connected by a communication bus 210: a processor or CPU (“Central Processing Unit”) 201; a random access memory RAM 202; a memory 203, for example of the ROM (“read-only memory”) or EEPROM (“Electrically Erasable Programmable ROM”) type, such as a flash memory; a storage unit, such as a hard disk drive HDD 204, or a storage medium reader, such as an SD (“Secure Digital”) card reader; and at least one communication module COM 205.

The communication module COM 205 is configured to enable the balancing management device 200 to interact with the information system SI, the data concentrator DC or the electricity meters C1 to Ck+1.

The processor 201 is capable of executing instructions that form a computer program and are loaded in the random access memory 202 from the read-only memory 203, from an external memory, from a storage medium (such as an SD card), or from a communication network. When the hardware platform is powered up, the processor 201 is capable of reading the aforementioned instructions from the random access memory 202 and executing them. When they are read from the random access memory 202 or a storage medium and executed by the processor 201, these instructions (which form a computer program) cause the execution, by the processor 201, of all or some of the steps or methods or more broadly the operating sequences described in the present disclosure.

All or some of the steps and operations described here can thus be implemented in software form by executing a set of instructions by a programmable machine, for example a processor of the DSP (“digital signal processor”) type or a microcontroller, or be implemented in hardware form by a machine or a dedicated electronic component (“chip”) or a dedicated set of electronic components (“chipset”), for example an FPGA (“field-programmable gate array”) or an ASIC (“application-specific integrated circuit”) component. In general terms, the balancing management device 200 comprises electronic circuitry adapted and configured to implement all or some of the operations, methods and steps described below.

It should be noted that the term “module” may correspond both to a software component and to a hardware component or a set of hardware and software components, a software component itself corresponding to one or more computer programs or sub-programs or more generally to any elements of a program able to fulfil a function or a set of functions.

FIG. 3 illustrates schematically the steps of the method for balancing loads in a polyphase electrical network, according to one embodiment. All or part of the balancing method is used (or implemented) in the management device 200 as described previously.

During a step E301, for each connection point supplied with electricity by the phase or phases L1′, L2′, L3′ of a substation in question (e.g. substation 102), data referred to as “topological data of the electricity network 1032”, are obtained by the management device 200.

These topological data of the electricity network 1032 correspond to information describing the structure and the connections between the various elements of the network, such as the transformers, the distribution lines, the substations and the electricity meters. They include the geographical and functional arrangement of these elements, the hierarchy and supply relationships between the components of the network, and the points for measuring the consumption and quality of the electricity. These topological data are, for example, supplied to the management device 200 by the information system SI.

According to one embodiment, the topological data furthermore comprise first data referred to as “phase configuration data”. These phase configuration data correspond to information describing the correlation, for each connection point, between the phase or phases L′, L2′, L3′ to which one or more output phases of the single-phase or polyphase connection of the subscriber are initially connected, and the input phases L′, L2′, L3′ starting from the corresponding substation 102. In other words, the configuration data represent the phase or phases to which the connection point of the subscriber is connected i.e. supplied with electricity) at a time t. For example, these phase configuration data make it possible to identify the input phase L1′, L2′, L3′ starting from the substation 102 to which an output phase of the connection point of the subscriber is initially connected (the case of a single-phase connection point). These phase configuration data are, for example, supplied to the management device 200 by the information system SI.

Then, during a step E302, the management device 200 obtains, for each connection point supplied with electricity by the input phase or phases L1′, L2′, L3′ of the substation 102 in question and for a predetermined period, second data referred to as “electrical energy consumption data” (e.g. in the form of load curves or tables). For this purpose, the management device 200 interrogates each electricity meter C1 to Ck+1 equipping the connection points in question and, for the predetermined period in question, obtains these electrical energy consumption data.

By means of the phase configuration data and the electrical energy consumption data of each connection point, the management device 200 then determines the total mean consumption (in kWh) for each input phase L1′, L2′, L3′ connected to a predetermined group of connection points, during the predetermined period.

Then, during a step E303, the management device 200 estimates, from the total mean consumption of each input phase L1′, L2′, L3′ a predicted mean consumption (in kWh) over a predetermined period, for each input phase L1′, L2′, L3′ supplying electrical energy to a predetermined group of connection points.

Then, during a step E304, the management device 200 estimates, for each input phase L1′, L2′, L3′ starting from a substation 102 in question, the share of predicted consumption for each input phase L1′, L2′, L3′ as a percentage with respect to a predicted total consumption of all the input phases L1′, L2′, L3′ over a predetermined period. Ideally, in a three-phase electrical network, the mean distribution of the electrical consumption is 33.33% of the total consumption for each input phase L1′, L2′, L3′ starting from a substation 102 in question. For example, the management device 200 estimates that the share of predicted total consumption over a predetermined period of the first input phase L1′ is 10%, that of the second input phase L2′ is 50% and that of the third phase L3′ is 40% (the total of the shares of total consumption of the input phases L1′, L2′, L3′ being 100%).

A load unbalance on the electrical network 1032 can be detected over a predetermined period.

For this purpose, according to one embodiment, during a step E305, the management device 200 next determines which are the input phases from all the input phases L1′, L2′, L3′ having the highest share of predicted total consumption (denoted Max (L1′, L2′, L3′)), and respectively the lowest (denoted Min (L1′, L2′, L3′)). If the difference between the value of the maximum share of predicted total consumption and the value of the minimum share of predicted total consumption is above a predetermined threshold (e.g. 10%) (response “yes” at the end of the step E305), then there is a load unbalance between the input phase the share of consumption which is the highest and the input phase the share of consumption of which is the lowest.

According to another embodiment, the management device 200 detects a load unbalance when the “voltage unbalance” is above a predetermined threshold. In particular, if the voltage unbalance is above a predetermined threshold (e.g. 8%) on a connection point at the end of the distribution chain, then there is a load unbalance. The voltage unbalance is determined in accordance with the following formula:

$$Voltage unbalance = \sqrt{\frac{6 * ( {U}_{12}^{2} + {U}_{23}^{2} + {U}_{31}^{2} )}{{) {U}_{12} + {U}_{23} + {U}_{31} )}^{2}} - 2} \qquad [ EQ1 ]$$

with Uij the effective phase to phase voltages measured by a meter equipping a connection point.

If a load unbalance is detected (response “yes” at the end of the step E305), the management device 200 passes to the step E306, otherwise (response “no” at the end of the step E305), it returns to the step E301 and reiterates the steps described above.

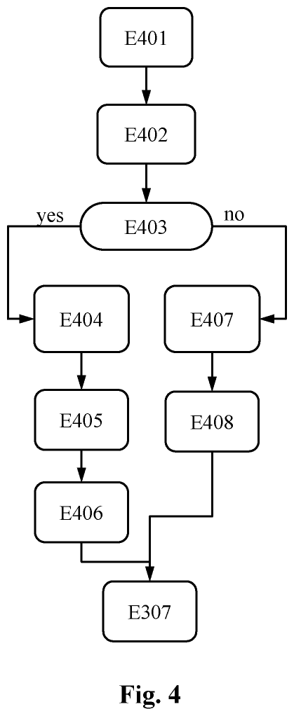

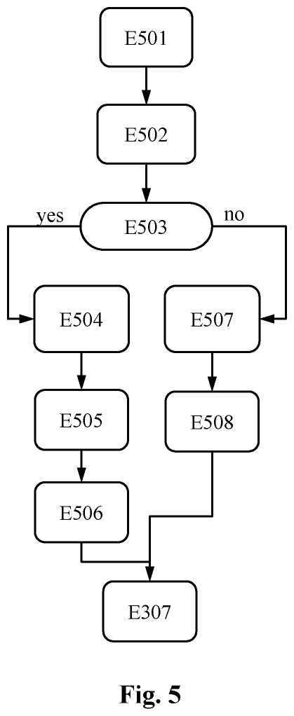

During the step E306, the management device 200 determines, for some of the connection points in a group of connection points supplied by the same input phase L1′, L2′, L3′, a phase connection change to be made for the selected connection points (see FIG. 4 and FIG. 5). Next, the management device 200 performs this phase connection change during a step E307.

This phase connection change corresponds to a switching of input phases for a connection point in question. For example, for a single-phase connection point, the phase connection change consists of the switching of an initial input phase with a new input phase. In another example, for a polyphase connection point, the phase connection change consists in modifying the order of the phases to which the output phases of the polyphase connection point are connected.

It is thus possible to switch from an initial phase configuration (i.e. the way in which the input phases are allocated and distributed at the connection point) to a new phase configuration making it possible to rebalance the load of each input phase of the electrical network 1032.

According to one embodiment, it is possible to define connection points the phase configuration which cannot be changed. For example, the management device 200 has in memory a list of connection points (e.g. identified from an identifier of an electricity meter equipping said connection point) the phase configuration of which cannot be changed. The connection points the phase configuration of which cannot be changed are, for example, connection points where it has been specified (e.g. by the subscriber or the electricity supplier) that the phase configuration will not be changeable or connection points that are not equipped with a suitable device for allowing switching of the input phases.

In an example of performing the phase connection change and thus establishing the new phase configuration or configurations (step E307), the management device 200 transmits to a suitable device integrated in the electricity meter equipping the connection point in question, or placed, in a suitable box upstream of the electricity meter equipping the connection point in question, a phase connection change request for switching, where applicable, from a connection to an input phase to which an output phase of the connection point in question is initially connected to a connection of said output phase to a new input phase. This suitable device is then able to physically configure each of the input phases on an output phase or not to take into account the new input phase (e.g. the case where there is no voltage in the new input phase).

The phase connection change request comprise in particular the phase connection changes (e.g. switching of input phases or changes in the order of the input phases) to be made. For example, in the case of a single-phase connection point, the phase connection change request indicates that the input phase initially connected to the connection point must be disconnected and that a new input phase (the identity of which is supplied in the request) must be connected to the connection point.

According to one embodiment, the management method described above is repeated regularly, with a programmable periodicity, defined by the use cases: twice per day (off-peak hours, peak hours), once per day, once per week, twice per month, once per month, etc FIG. 4 illustrates schematically certain steps of the management method described previously according to one embodiment. In particular, FIG. 4 details the step E306 of determining a phase connection change to be made, according to a first embodiment.

During a step E401, in order to determine which phase connection change or changes is or are to be made, and for which connection point or points supplied by the substation 102 in question, the management device 200 classifies the input phases L1′, L2′, L3′ of the substation 102.

For this purpose, according to one embodiment, the management device 200 classifies the input phases L1′, L2′, L3′ in a decreasing order of share of predicted total consumption. For example, if the share of predicted total consumption of the first input phase L1′ is 10%, that of the second input phase L2′ is 50% and that of the third phase L3′ is 40, then the second input phase L2′ is greater than the third phase L3′, which is greater than the first input phase L1′ (L2′>L3′>L1′) in terms of share of predicted total consumption.

In other words, at the end of this step E401, the management device 200 has determined which are the input phases having a highest predicted total consumption over a predetermined period (e.g. the second input phase L2′), and respectively intermediate (e.g. the second input phase L3′), and respectively the lowest (e.g. the second input phase L1′), among the input phases L1′, L2′, L3′

Next, during a step E402, the management device 200 classifies, in a decreasing order of predicted mean electrical consumptions over a predetermined period, the connection points initially supplied by the input phase having the highest share of predicted total consumption (e.g. the connection points initially supplied by the second input phase L2′). In order to have balanced loads over all the input phases L1′, L2′, L3′, it is necessary to reduce the share of predicted total consumption of the input phase having the highest share of predicted total consumption to bring it to approximately 33.33% of said predicted total consumption. This corresponds to a first gain in electricity consumption denoted Y2 (in kWh). For example, the share of predicted total consumption of the second input phase L2′ is 50%, then it is necessary to reduce the share of predicted total consumption of the second input phase L2′ by approximately 16.67%.

The management device 200 next selects, in the decreasing order of predicted mean consumptions over the predetermined period, the connection points a predicted total mean consumption of which over the predetermined period is equal to the first gain in consumption Y2 (in kWh).

During a step E403, the management device 200 determines whether the share of predicted total consumption over the predetermined period of the input phase having the share of predicted total consumption intermediate between the highest share of total consumption and the lowest (e.g. third input phase L3′) is above a threshold S of 33.33%.

If the intermediate share of predicted total consumption is greater than 33.33% (response “yes” at the end of the step E403), then the management device 200 decides to switch the connection points selected during the step E402 of the input phase having the highest share of predicted total consumption (e.g. second input phase L2′) onto the input phase having the lowest share of predicted total consumption (e.g. first input phase L1′). Thus, the connection points selected in step E402 are connected to a new input phase (e.g. input phase L1′), thus reducing the load on the input phase to which they were initially connected.

Then, during a step E405, the management device 200 next selects, in the decreasing order of predicted mean consumptions over the predetermined period, the connection points initially supplied by the input phase having the intermediate share of predicted total consumption (e.g. the connection points initially supplied by the third input phase L3′) a predicted total mean consumption of which over the predetermined period is equal to a second gain in consumption Y3 (in kWh). This is because, in order to have balanced loads over all the input phases L1′, L2′, L3′, it is necessary to reduce the share of predicted total consumption of the input phase having the intermediate share of predicted total consumption to bring it to approximately 33.33% of said predicted total consumption. This corresponds to a second gain in consumption denoted Y3 (in kWh). For example, the share of predicted total consumption of the third input phase L3′ is 40%, then it is necessary to reduce the share of predicted total consumption of the third input phase L3′ by approximately 6.67%.

Then, during a step E406, then the management device 200 decides to switch the connection points selected during the step E405 of the input phase having the intermediate share of predicted total consumption (e.g. third input phase L3′) onto the input phase having the lowest share of predicted total consumption (e.g. first input phase L1′). The management device 200 next performs the step E307 described above. In particular, the management device 200 transmits, to the connection point or points concerned, the phase connection change request with the new configuration to be established.

On the other hand, if the intermediate share of predicted total consumption is less than or equal to 33.33% (response “no” at the end of the step E403), then the management device 200 selects (step E407) in the decreasing order of the predicted mean consumptions over the predetermined period, connection points selected during the step E402 until a third gain in consumption denoted Y1 (in kWh) is obtained. The management device 200 next decides to switch these connection points selected during the step E402 and during the step E407 to the input phase having the lowest share of predicted total consumption (e.g. first input phase L1′). The third gain in consumption Y1 corresponds to the difference between 33.33% and the share (as a percentage) of the predicted total consumption of the input phase having the lowest share of predicted total consumption.

Then, during a step E408, the management device 200 selects, in the decreasing order of the predicted mean consumption s over the predetermined period, the connection points selected during the step E402 that are remaining (i.e. that were not selected during the step E407), and next decides to switch these remaining connection points selected during the step E402 to the input phase having the intermediate share of predicted total consumption (e.g. third input phase L3′). The management device 200 next performs the step E307 described above.

According to the embodiment described above, it is the connection points the predicted consumption of which over the predetermined period is the highest that have their connection switched from a connection to one or more initial input phases to one or more new input phases.

FIG. 5 illustrates schematically certain steps of the management method described previously, according to another embodiment. In particular, FIG. 5 details the step E306 of determining a phase connection change to be made, according to a second embodiment.

As described previously in relation to the step E401, the management device 200 classifies (step E501) the input phases L1′, L2′, L3′ in a decreasing order of share of predicted total consumption over a predetermined period.

Next, during a step E502, the management device 200 randomly selects connection points initially supplied by the input phase having the highest share of predicted total consumption (e.g. the connection points initially supplied by the second input phase L2′) a predicted total mean consumption of which over a predetermined period is equal to the first gain in consumption Y2 (in kWh) described previously.

During a step E503, similar to the step E403, the management device 200 determines whether the share of predicted total consumption of the input phase having a share of predicted total consumption intermediate between the highest share of predicted total consumption and the lowest (e.g. third input phase L3′) is above or equal to a threshold S of 33.33%.

If the intermediate share of predicted total consumption is greater than 33.33% (response “yes” at the end of the step E503), then the management device 200 decides to switch the connection points selected during the step E502 of the input phase having the highest share of predicted total consumption (e.g. second input phase L2′) to the input phase having the lowest share of predicted total consumption (e.g. first input phase L1′).

Then, during a step E505, the management device 200 next selects, randomly, the connection points initially supplied by the input phase having the intermediate share of predicted total consumption (e.g. the connection points initially supplied by the third input phase L3′) a predicted total mean consumption of which over the predetermined period is equal to the second gain in consumption Y3 (in kWh) as described previously. Then, during a step E506, the management device 200 decides to switch the connection points selected during the step E505 of the input phase having the intermediate share of predicted total consumption (e.g. third input phase L3′) to the input phase having the lowest share of predicted total consumption (e.g. first input phase L1′). The management device 200 next performs the step E307 described above.

On the other hand, if the intermediate share of predicted total consumption is less than or equal to 33.33% (response “no” at the end of the step E503), then the management device 200 randomly selects connection points selected during the step E502 until the third gain in consumption denoted Y1 (in kWh) as described above is obtained. The management device 200 next decides to switch these connection points selected during the step E502 and the step E507 to the input phase having the lowest share of predicted total consumption (e.g. first input phase L1′).

Then, during a step E508, the management device 200 selects the connection points selected during the step E502 that are remaining (i.e. that were not selected during the step E507), and next decides to switch these remaining connection points selected during the step E502 to the input phase having the intermediate share of predicted total consumption (e.g. third input phase L3′). The management device 200 next performs the step E307 described above.

According to the embodiment described above, it is not necessary to always select the connection points at the highest predicted consumption over the predetermined period. Thus, more connection points can be selected, since those adopted are not systematically the greatest consumers of electricity.

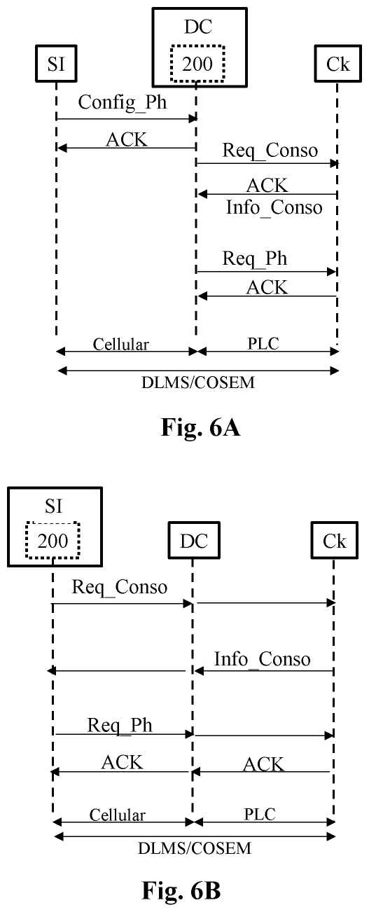

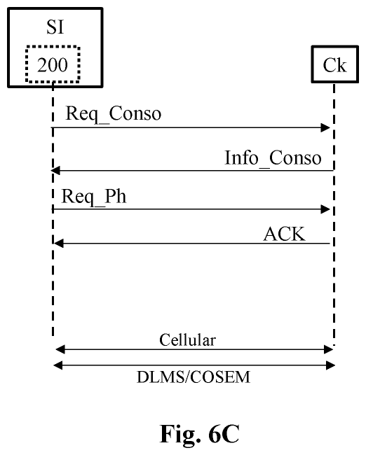

FIGS. 6A, FIG. 6B and FIG. 6C illustrate in flow diagram form examples of communication flows during the management method as described previously.

By way of illustration, it is considered that the appropriate device (i.e. allowing switching of the input phases) described previously is integrated in an electricity meter.

According to one embodiment, an example of which is illustrated in FIG. 6A, the management device 200 is integrated in the data concentrator DC. As described previously, the information system SI transmits, to the data concentrator DC, via the first communication network 101, the topological data including the phase configuration data (Config_Ph). In return, the data concentrator DC transmits a data reception confirmation message (ACK). The data concentrator DC then transmits to each meter Ck a request (Req_Conso) for the electrical energy consumption data for the input phase or phases to which the output phase or phases of the connection point are connected, via the second communication network. The meters Ck in return transmit the electrical energy consumption data (Info_Conso) as well as a confirmation of reception of the data (ACK). The data concentrator DC next implements the balancing management method as described above, via the balancing management device 200. The data concentrator DC next transmits to the electricity meters Ck a phase connection change request (Req_Ph) to switch a connection of one or more input phases to which one or more output phases of a connection point is (are) initially connected, with a connection of said output phase or phases to one or more new input phases.

According to another embodiment, an example of which is illustrated in FIG. 6B, the management device 200 is integrated in the information system SI. As described previously, the information system SI already has the topological data including the phase configuration data. The information system SI then transmits to each meter Ck a request (Req_Conso) for the electrical energy consumption data for the input phase or phases to which the output phase or phases of the connection point are connected, via the data concentrator DC. The meters Ck in return transmit the electrical energy consumption data (Info_Conso) to the information system SI via the data concentrator DC. The information system SI next implements the balancing management method as described above, via the balancing management device 200. The information system SI next transmits to the electricity meters Ck a phase connection change request (Req_Ph) to switch a connection of one or more input phases to which one or more output phases of a connection point are initially connected, with a connection of said output phase or phases to one or more new phases.

According to another embodiment, an example of which is illustrated in FIG. 6C, the management device 200 is integrated in the information system SI. Unlike the example in FIG. 6B, the information system SI communicates directly with the meters Ck via a communication network 104.

According to one embodiment, the information system SI, the data concentrator DC and the meters C1 to Ck exchange information and data via the DLMS/COSEM protocol.

For example, a DLMS/COSEM object: “Switching Phases” is created to make it possible to modify the connection phases of the connection points, whether they be single-phase or polyphase. The attributes of this new DLMS command are (the case of a three-phase network with a three-phase connection point):
connection Input phase 1 to any subscriber output phase or to output phase 1, 2 or 3;
connection Input phase 2 to any subscriber output phase or to output phase 1, 2 or 3;
connection Input phase 3 to any subscriber output phase or to output phase 1, 2 or 3.

This object naturally manages the forbidden cases:
in the single-phase case, only the connection to the output phase is enabled and only one input phase can be connected to the output at the same time,
in the polyphase case, connecting a plurality of input phases to one and the same output phase or a plurality of output phases to one and the same input phase is forbidden.

1. A method for managing the balancing of the loads in an electrical network comprising a plurality of phases supplying electrical energy to a set of connection points adapted to connect an electrical installation of a subscriber to said electrical network, wherein said method is implemented in a management device, wherein said method comprises:
obtaining, for each connection point, first data representing at least one phase from said plurality of phases to which each connection point is connected,
obtaining, for each connection point, second data representing a consumption of electrical energy over a predetermined period for said at least one phase to which said connection point is connected,
estimating, according to the first data and a mean consumption determined on the basis of said second data, a predicted total electrical energy consumption over a predetermined period for each phase in said plurality of phases,
detecting any load unbalance between said phases from said predicted total electrical energy consumption, and
when a load unbalance is detected, then commanding a phase connection change, said phase connection change comprising:
classifying, by decreasing order of predicted total electrical energy consumption over the predetermined period, said phases in said plurality of phases, a first phase being a phase having the highest predicted total electrical energy consumption, a second phase being a phase having an intermediate predicted total electrical energy consumption, a third phase being a phase having the lowest predicted total electrical energy consumption;
for said first phase, selecting a first set of connection points selected from a group of connection points supplied by said first phase, until a predicted total electrical energy consumption over the predetermined period of the connection points reaches a first predetermined gain in consumption.

2. The method according to claim 1, wherein detecting a load unbalance between said phases comprises:
determining, from said predicted total electrical energy consumption of each phase, the phases having a predicted total electrical energy consumption over the predetermined period that is the highest, and respectively the lowest, and,
if a difference in predicted total electrical energy consumption between the phases having the highest and the lowest predicted total electrical energy consumption is above a predetermined threshold, then said load unbalance is detected.

3. The method according to claim 1, wherein selecting, for said first phase, said first set of connection points is performed in a decreasing order of predicted mean electrical energy consumption over the predetermined period, and commanding said phase connection change furthermore comprises:
if a predicted total electrical energy consumption of said second phase is higher than a predetermined threshold, then:
commanding a switching of the connection points of said first selected set onto a connection to said third phase, and
selecting, in a decreasing order of a predicted mean electrical energy consumption over the predetermined period, a second set of connection points selected from a group of connection points supplied by said second phase, until a predicted total electrical energy consumption over the predetermined period of the connection points reaches a second predetermined gain in consumption, and commanding a switching of the connection points of said second selected set onto a connection to said third phase.

4. The method according to claim 3, wherein commanding said phase connection change furthermore comprises:
when the predicted total electrical energy consumption of said second phase is below or equal to a predetermined threshold, then
selecting, in a decreasing order of a predicted mean electrical energy consumption over the predetermined period, a third set of connection points selected from the connection points of said first set, until a predicted total electrical energy consumption over the predetermined period of the connection points reaches a third predetermined gain in consumption, and commanding a switching of the connection points of said third set onto a connection to said third phase, and
selecting, in a decreasing order of a predicted mean electrical energy consumption over the predetermined period, the remaining connection points of said first set and commanding a switching of the remaining connection points of said first set onto a connection to said second phase.

5. The method according to claim 1, wherein selecting, for said first phase, said first set of connection points is performed randomly, and commanding said phase connection change furthermore comprises:
if a predicted total electrical energy consumption of said second phase is higher than a predetermined threshold, then:
commanding a switching of the connection points of said first selected set onto a connection to said third phase, and
selecting, randomly, a second set of connection points selected from a group of connection points supplied by said second phase, until a predicted total electrical energy consumption over the predetermined period of the connection points reaches a second predetermined gain in consumption, and commanding a switching of the connection points of said second selected set onto a connection to said third phase.

6. The method according to claim 5, wherein said phase connection change furthermore comprises:
when the predicted total electrical energy consumption of said second phase is below or equal to a predetermined threshold, then
selecting, randomly, a third set of connection points selected from said first set until a predicted total electrical energy consumption over the predetermined period of the connection points reaches a third predetermined gain in consumption, and commanding a switching of the connection points of said third set onto a connection to said third phase, and
selecting the remaining connection points of said first set and commanding a switching of the remaining connection points of said first set onto a connection to said second phase.

7. A management device for managing the balancing of the loads in an electrical network comprising a plurality of phases supplying electrical energy to a set of connection points adapted to connect an electrical installation of a subscriber to said electrical network, wherein said management device comprises electronic circuitry configured to:
obtain, for each connection point, first data representing at least one phase from said plurality of phases to which each connection point is connected,
obtain, for each connection point, second data representing a consumption of electrical energy over a predetermined period for said at least one phase to which said connection point is connected,
estimate, according to the first data and a mean consumption determined on the basis of said second data, a predicted total electrical energy consumption over a predetermined period for each phase in said plurality of phases,
detect any load unbalance between said phases from said predicted total electrical energy consumption, and
when a load unbalance is detected, then commanding a phase connection change, said phase connection change comprising:
classifying, by decreasing order of predicted total electrical energy consumption over the predetermined period, said phases in said plurality of phases, a first phase being a phase having the highest predicted total electrical energy consumption, a second phase being a phase having an intermediate predicted total electrical energy consumption, a third phase being a phase having the lowest predicted total electrical energy consumption;
for said first phase, selecting a first set of connection points selected from a group of connection points supplied by said first phase, until a predicted total electrical energy consumption over the predetermined period of the connection points reaches a first predetermined gain in consumption.

8. The management device according to claim 7, integrated in an information system of an electricity supplier.

9. The management device according to claim 7, integrated in a data concentrator.

10. (canceled)

11. A non-transitory storage medium, storing a computer program comprising instructions causing the execution, by a processor, of the method according to claim 1, when said instructions are read from the storage medium and executed by the processor.
